(19) United States
(12) Patent Application Publication
(10) Pub. No.: US 2024/0098849 A1
(43) Pub. Date: Mar. 21, 2024

(54) Handheld Warming Device

(71) Applicant: Waters Industries, Inc., West Dundee, IL (US)

(72) Inventor: Michael Waters, Aspen, CO (US)

(21) Appl. No.: 18/368,692

(22) Filed: Sep. 15, 2023

Related U.S. Application Data
(60) Provisional application No. 63/406,772, filed on Sep. 15, 2022.

(51) Int. Cl. H05B 3/06

(52) U.S. Cl. CPC H05B 3/06

(57) ABSTRACT

There is provided a personal warming device having an inner core having a housing containing a power source, and a heating sleeve that extends about substantially the entire perimeter of the housing. The personal warming device further includes a jacket that provides a substantially fluid-tight seal about the inner core.

### CROSS-REFERENCE TO RELATED APPLICATION

This application claims the benefit under 35 U.S.C. § 119(e) to U.S. Provisional Application No. 63/406,772, filed Sep. 15, 2022, entitled HANDHELD WARMING DEVICE, which is hereby incorporated by reference in its entirety.

### FIELD

This disclosure relates to warming devices and, more particularly, to handheld warming devices.

### BACKGROUND

Portable warmers are often used to regulate body temperatures in cold conditions. Portable warmers may be used to heat anatomical extremities such as feet, toes, hands, and fingers. Some warmers produce heat through exothermic oxidation of iron when exposed to air. However, such warmers are typically “one-time use” warmers and expire after about an hour of use. Other warmers require flammable lighter fuel and an open flame for heat, which combination may be undesirable in many environments. Still other warmers utilize batteries to produce heat. Many such warmers, however, only propagate heat in localized areas, such as front or back surfaces of the warmer. Furthermore, many existing warmers must be concealed from the environment, as water, dust, and other debris may enter and impair or ruin the heating function.

### BRIEF DESCRIPTION OF THE DRAWINGS

FIG. 1 is a perspective view of a handheld warming device showing a resilient outer jacket having a main body and an upper cap with the cap in the closed position on the main body.

FIG. 2 is a perspective view of the handheld warming device with the upper cap in the open position to expose an upper surface of an upper control portion of an inner core including user-interfacing components with the open cap remaining connected to the main body using a living hinge.

FIG. 3 is an exploded view of the handheld warming device showing the upper cap with the living hinge removed having a resilient relief or projection for being aligned with an actuator of the user interfacing components and indentations aligned with lights of the user-interfacing components for shining through the cap.

FIG. 4 is a perspective view of the inner core of the handheld warming device showing a heating sleeve wrapped around a housing of the inner core to form a lower, heating portion thereof.

FIG. 5 is an exploded view of the inner core showing a power source received between housing portions, and the heating sleeve including coil traces that extend about the housing components.

FIG. 6 is a cross-sectional view taken along line 6-6 of FIG. 2 showing the living hinge between the cap and main body of the outer jacket, and showing the power source within the housing, and the circuit board, switch device, lights, and recharging socket within the upper, control portion.

FIG. 7 is a cross-sectional view taken along line 7-7 of FIG. 2 showing a tab portion of the heating sleeve in contact with the power source and the circuit board.

FIG. 8 is a front view showing the heating sleeve extending along substantially the entirety of the front surface of the housing of the inner core.

FIG. 9 is a first side view showing the heating sleeve extending across substantially the entirety of one of the arcuate ends of the housing of the inner core.

FIG. 10 is a second side view showing the heating sleeve extending across substantially the entirety of the opposite arcuate end of the housing of the inner core.

FIG. 11 is a rear view showing the heating sleeve extending along substantially the entirety of the rear surface of the housing of the inner core.

FIG. 12 is a partially exploded view of the inner core showing the heating sleeve unwrapped from around the housing in a generally planar, flipped up orientation, and the front housing portion detached from the rear housing portion to reveal the batteries.

FIG. 13 is a view of an upper portion of the inner core with the front housing portion removed to show the circuit board electrically coupled to the batteries and the heating sleeve.

FIG. 14 is a schematic showing electrical circuitry of the warming device including a processor in communication with the switch device, the recharging socket, a thermistor, a transistor, and a charging controller.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures is combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

In general, a portable (e.g., handheld) warming device is provided. The warming device includes a heat-generating inner core and a resilient outer jacket that surrounds the inner core. The inner core includes a power source, and a heating layer or sleeve including heating coil traces powered by the power source for generating and distributing the heat around substantially the entire outer perimeter of the inner core, and preferably covering substantially the entirety of the front, back, and side wall portions of the inner core. The outer jacket includes a main body portion that snugly wraps around the inner core, and a cap for being removably secured on the body portion so that the inner core is completely encased in the outer jacket. With the cap removably secured on the body portion, the cap and body portion of the outer jacket cooperate to form a fluid-tight or substantially fluid-tight seal to keep fluid from accessing the inner core. For example, the outer jacket may form a seal sufficient to comply with Ingress Protection (IP) rating of IPX7.

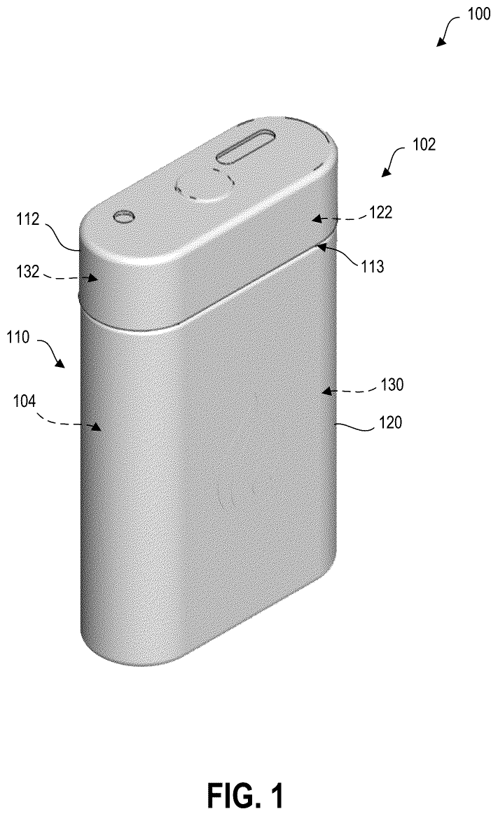

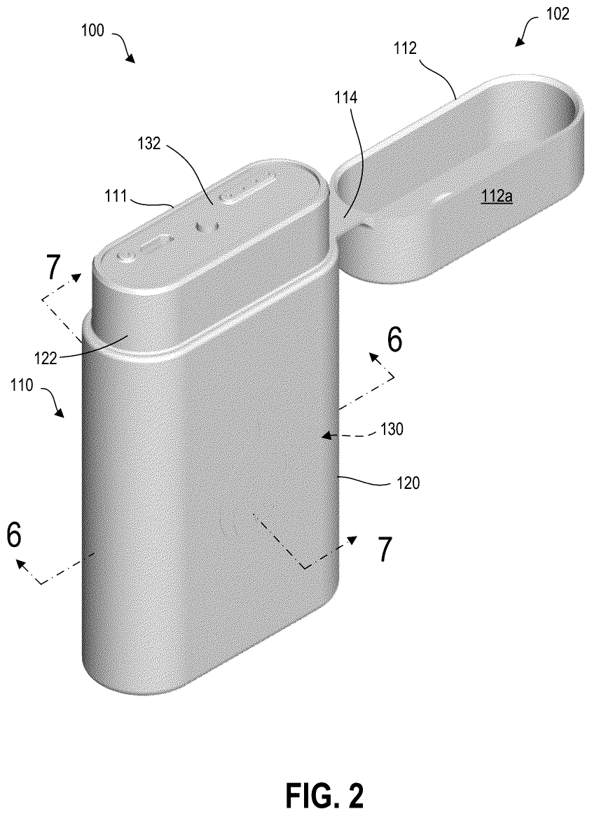

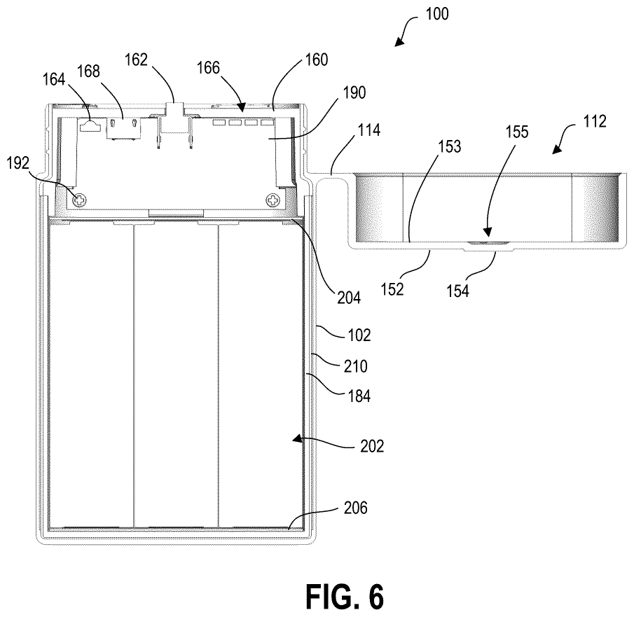

Referring to FIGS. 1 and 2, a warming device 100 is shown having a resilient outer jacket 102 that surrounds an inner core 104. The outer jacket 102 includes a body portion 110 and a cap 112. As shown in FIGS. 2 and 6, the cap 112 may be connected to the body portion 110 via a living hinge 114. In this way, the body portion 110 and cap 112 may be formed as a unitary outer jacket 102 which is preferably of a molded, resilient material. In another approach, the cap 112 may be formed as a distinct component separate from the body portion 110. The outer jacket 102 is formed of a heat transmissible material such that heat is readily transferred from a heating portion 130 of the inner core 104 through the outer jacket 102, and to a user's hand engaged thereon. The outer jacket 102 may be formed of a material that is comfortable to the touch and has slip resistant properties. For example, one or both of the body portion 110 and the cap 112 may be formed of silicone and may have a durometer of approximately 65 on a Shore 00 scale.

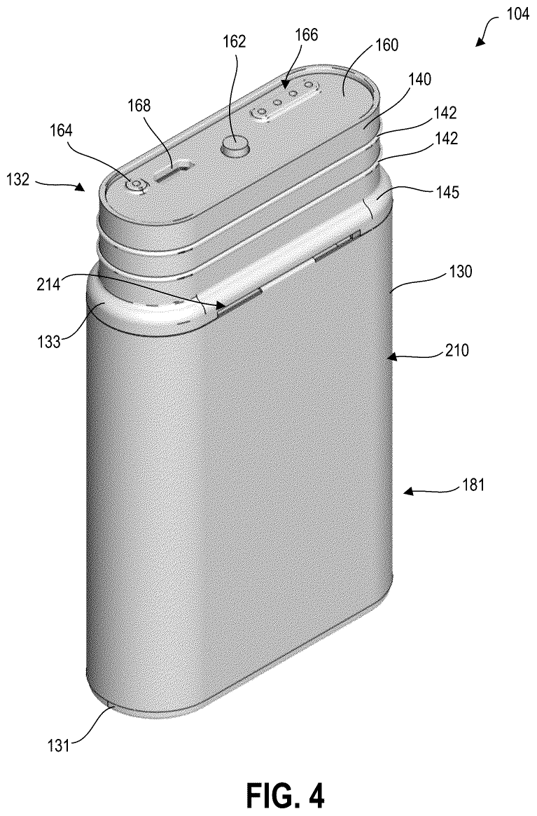

The body portion 110 includes a main body 120 and a neck 122 that extends from the main body 120 to an upper end 111 of the body portion 110, as shown in FIG. 2. The main body 120 is sized to wrap around and form an intimate, snug fit with a lower, heating portion 130 of the inner core 104. The neck 122 is sized to wrap around and form a snug fit with an upper, control portion 132 of the inner core 104. As can be seen in FIG. 4, an outer surface 140 of the control portion 132 may include one or more annular ribs 142 to retain the neck 122 along the outer surface 140, as discussed in greater detail below.

Referring to FIG. 2, the main body 120 and neck 122 both have an oval or race-track shape in cross-section with the oval cross-sectional shape of the main body 120 being larger than that of the neck 122 and the neck 122 being centered relative to the main body 120. In this regard, the long and short axes of the cross-section of the main body 120 are larger than the corresponding axes of the cross-section of the neck 122 so that a shoulder surface 143 is formed therebetween extending transverse to the main body 120 and neck 122. For example, the cross-section of the main body 120 may have a long axis of approximately 2.5 inches and a short axis of approximately 1 inch, and the cross-section of the neck 122 may have a long axis of approximately 2.25 inches and a short axis of approximately 0.75 inches. The living hinge 114 extends from the shoulder surface 143 at one of the arcuate ends thereof to the cap 112.

The inner core 104 has a similar cross-section to the body portion 110 and cap 112 when the cap 112 is closed on the body portion 110. Thus, the lower, heating portion 130 has an oval or race-track cross-sectional configuration that is larger than the oval or race-track cross-sectional configuration of the upper control portion 132 which is centered relative to the lower, heating portion 130. A housing 180 of the inner core 104, which will be described more fully hereinafter, may be formed, for example, of a rigid plastic material such as acrylonitrile butadiene styrene.

As discussed, the body portion 110 is sized and secured to the inner core 104 to form a snug fit about the inner core 104. In this way, the body portion 110 inhibits water and debris from accessing and contacting the inner core 104. In one example approach, the outer jacket 102 is formed in a cavity of a first mold. The outer jacket 102 is then placed in a cavity of a second mold that is larger than the body portion 110 of the outer jacket 102. A vacuum is then applied to the second mold cavity such that the body portion 110 is pulled towards the walls of the cavity and expands outwardly within the second mold cavity. The inner core 104 is then inserted into the expanded body portion 110, and the vacuum is released, thereby relaxing the expanded body portion 110 so that it returns toward its original unexpanded configuration. In this manner, the body portion 110 engages and tightly grips the inner core 104 so that it forms an intimate, tight fit about the inner core 104. Such tight fit reduces or eliminates air gaps between the body portion 110 and the inner core 104, which provides efficient heat transfer from the inner core 104 to the main body 120 of the body portion 110 during use of the warming device 100, as discussed in detail below. Such tight fit also causes the neck 122 of the body portion 110 to tightly grip the outer surface 140 of the control portion 132 of the inner core 104. More particularly, when the vacuum is released, the neck 122 retracts and tightly engages the annular ribs 142 about the entire perimeter of the control portion 132 to form a seal between the neck 122 and the outer surface 140 of the control portion 132. The tight grip of the neck 120 along the ribs 142 may also cause the neck 120 to protrude outwardly at the ribs 142 such that the protruding regions of the neck 122 help retain the cap 112 and form a seal with the cap 112 when the cap 112 is friction fit in the closed position.

The cap 112 may be removably secured to the reduced size neck 122 of the body portion 110. As shown in FIG. 2, with the body portion 110 wrapped around the inner core 104, the smaller neck 122 has a smaller outer perimeter than the larger main body 120. The cap 112 also has an oval or race-track shape in cross-section and has an inner perimeter that is approximately the same as or just greater than the outer perimeter of the neck 122 such that the cap 112 and neck 122 form a friction-fit engagement therebetween. The outer perimeter of the cap 112 is approximately the same as the outer perimeter of the main body 120 such that the thickness of the annular cap wall 112a is approximately the same as the width of the shoulder surface 143. Accordingly, with the cap 112 secured on the neck 122, they may cooperate to form a substantially flush outer surface of the jacket 102 along the main body 120 and the cap 112, albeit with a seam 113 therebetween.

In one approach, the friction fit securement of the cap 112 on the body portion 110 forms a fluid-tight or substantially fluid-tight seal between the cap 112 and the body portion 110. The seal may be sufficient to comply with, for example, Ingress Protection (IP) rating of IPX7. In this way, the outer jacket 102 provides a waterproof cover to protect the components of the inner core 104 from water and dust to allow for rugged outdoor use of the warming device 100.

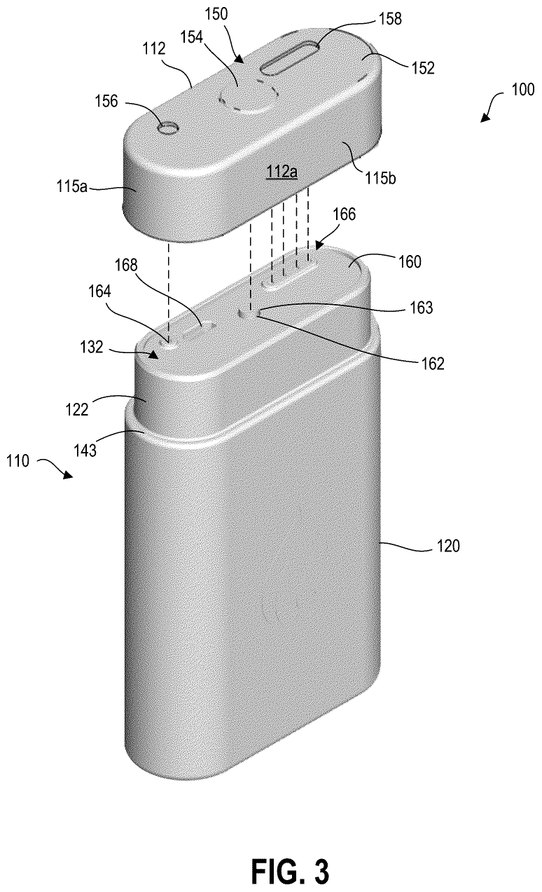

Referring to FIG. 3, the cap 112 may include externally-facing features 150, such as a relief or projection and indents or recesses formed in an upper surface or wall 152 of the cap 112. The upper wall 152 is sized to close off the top of the annular cap wall 112a so that it extends to the opposite arcuate end wall portions 115a and opposite straight side wall portions 115b thereof. The features 150 may be generally aligned with components (discussed in greater detail below) at an upper surface 160 of the control portion 132 of the inner core 104 when the cap is in its closed position extending over and engaged with the neck 122. For example, the cap 112, may include a relief or projection 154 that has a circular configuration and is generally aligned with an actuator 163 of a switch device 162 of the control portion 132. The switch device 162 may be a push-button type switch device 162 so that the actuator 163 is in the form of a plunger 163. A user may press on the relief 154 to cause the relief 154 to flex downwardly, thereby depressing the plunger 163 to actuate the switch device 162 to change modes of the warming device 100, as will be discussed hereinafter. As shown in FIG. 6, a recess 155 can be formed in an inner surface 153 of the upper wall 152 aligned with the relief 154 such that the upper wall 152 has the same thickness at the relief 154 as it does in the remaining non-indented area thereof. When the cap 112 is in the closed position over and engaged with the neck 122, the plunger 163 of the switch device 162 extends beyond the inner surface 153 and into the recess 155 of the upper wall 152.

As indicated above, the cap 112 may also include first and second indents 156, 158. A first indent 156 may be aligned with a first light or LED 164, which may be a battery level indicator light. The first indent 156 may be a generally circular indent. A second indent 158 may be aligned with a second light or array or series of lights or LEDs 166, which may be mode indicator lights. In this way, the second indent 158 may have a generally oval or racetrack shape. The first and second indents 156, 158 may have a material thickness that is less than the non-indented remainder of the upper wall 152 of the cap 112. In this way, light illuminated from the first light 164 and second series of lights 166 is shined through thinned wall areas at indents 156,158 to be more easily visible to a user through the thinner wall thickness of the first and second indents 156, 158.

In this way, the cap 112 may cover one or more of the components (e.g., the switch device 162, first light 164, second series of lights 166, and, as discussed below, recharging socket 168) of the control portion 132 such that the components are concealed and cannot be directly accessed when the cap 112 is secured via its friction fit with the neck 122 in its closed position.

Referring to FIG. 4, the inner core 104 includes user-interfacing components at the upper surface 160 of the control portion 132. For example, a user may actuate the switch device 162 to change modes of the warming device 100. As mentioned, the switch device 162 may include the plunger actuator 163. Other switch devices having different types of actuators such as a slide switch, a toggle switch, or a rotary switch may be used instead of the push-button switch device 162.

An initial actuation of the switch device 162 by a user may cause the warming device 100 to turn “on,” and may cause the warming device 100 to operate in “high heat” mode (e.g., approximately 130° F. or approximately 135° F.). More particularly, actuation of the switch device 162 effects to signal to a processor 165 that causes the processor 165 to change an operation mode of the warming device 100, as discussed in greater detail below. The warming device 100 may fully heat to the high heat temperature in approximately 50 seconds or less. With the warming device 100 heated to the high heat temperature, a user may feel a temperature of approximately 120° F. through the main body 120 of the jacket 102.

Also upon initial actuation, the first light 164 may blink different numbers of time to indicate corresponding different battery charge levels. For example, the first light 164 (which may be a first color such as green) may blink three times to indicate a high charge level, may blink only two times to indicate a medium charge level, or may blink only once to indicate a low charge level.

A subsequent, second actuation of the switch device 162 by a user may cause the warming device 100 to switch to a “medium high heat” mode (e.g., approximately 120° F.). A subsequent, third actuation of the switch device 162 may cause the warming device 100 to switch to a “medium low heat” mode (e.g., approximately 110° F.). A subsequent, fourth actuation of the switch device 162 may cause the warming device 100 to switch to a “low heat” mode (e.g., approximately 100° F.).

The second series of lights 166 may illuminate to indicate a heat level mode selected by the user via actuation of the switch device 162. For example, all of the series of lights 166 (e.g., four lights) may illuminate to indicate the warming device 100 is operating in the “high heat” mode. The number of illuminated lights 166 may be sequentially reduced as the user changes the operating mode from the “high heat” mode, to the “medium high heat” mode (three lights), to the “medium low heat” mode (two lights), and to the “low heat” mode such that only a single light 166 is illuminated in the “low heat” mode.

In one approach, each of the lights 166 is the same color, which may be different than the color of the first light 164. For example, each of the lights 166 may be red. In another approach, one or more of the lights 166 may be a color that is different than other lights 166.

The inner core 104 further includes a recharging interface in the form of an electrical connector opening or socket 168 opening at the upper surface 160 of the control portion 132. The recharging socket 168 is sized to receive an electrical connector of a recharging cord for supplying charging power for charging a rechargeable power source (discussed in greater detail below). The recharging socket 168 may include, for example, a universal serial bus (USB) interface that receives power from an external source through a USB charging cable. The USB interface may be a USB-A, USB-B, USB-C, USB, micro USB, or mini USB interface. Other suitable recharging interfaces such as Firewire, Lightning connector, or Ethernet interfaces may be used.

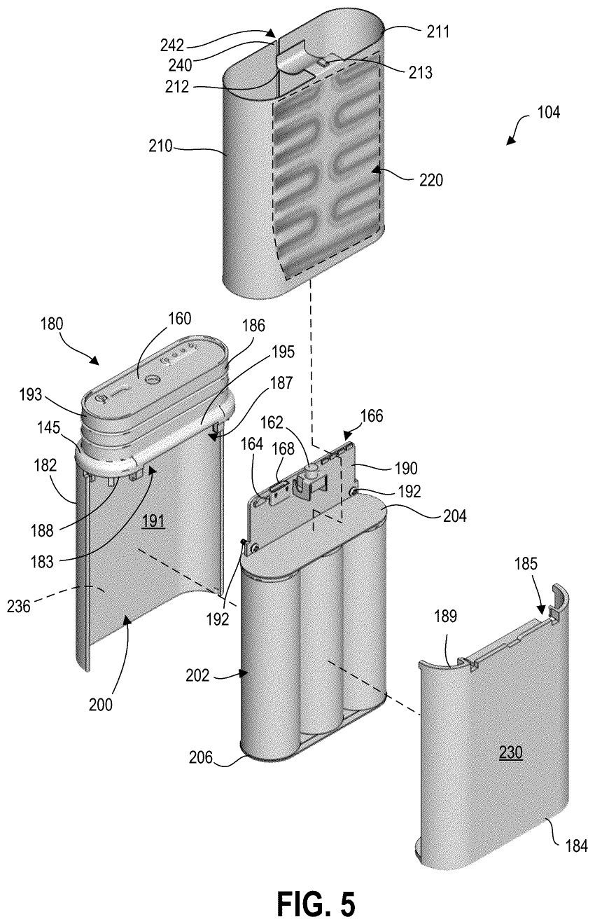

Referring to FIG. 4-7, the lower, heating portion 130 of the inner core 104 includes a housing 180 that forms internal space or cavity 200 for receiving internal components of the inner core 104. As mentioned earlier, the housing 180 can be of a plastic or polymeric material such as ABS. In the illustrated form, the housing 180 has a lower, battery housing portion 181. As can be seen in FIG. 5, the housing 180 can have a split or clam-shell construction so that it includes a rear housing portion 182 and a front housing portion 184. As discussed in greater detail below, a heating sleeve 210 includes an adhesive so that when it is wrapped about opposite first and second arcuate end surface portions 232, 234 of the lower housing portion 181 (as shown in FIGS. 9 and 10), the sleeve 210 will keep the rear housing portion 182 and the front housing portion 184 secured together to form the housing 180.

Continuing reference to FIG. 5, one of the housing portions 182, 184 of the housing 180 (e.g., the rear housing portion 182) includes an upper, control housing portion 186 integrally formed therewith. The control housing portion 186 has the annular, race-track cross-sectional configuration and is generally hollow so that the internal space 200 of the housing 180 extends therein to include an upper extension portion 187 of the internal space 200 for receiving a circuit board 190, which may be a printed circuit board (PCB), in the control housing portion 186. An arcuate shoulder surface 145 curves from the upper end of the main wall 191 of the rear housing portion 182 to the bottom end of the annular wall 193 of the control housing portion 186, and since both are annular, the shoulder surface 145 and control housing portion wall 193 are cantilevered beyond the main wall 191 of the rear housing portion 182 for extending over upper edge 189 of the front housing portion 184. Various components of the control portion 132 described herein, such as the switch device 162, the first light 164, the second series of lights 166, and the recharging socket 168 are mounted to the circuit board 190 such that they are also received in the internal space portion 187 formed by the control housing portion 186. As shown, the circuit board 190 is mounted on a side edge thereof to extend vertically adjacent the rear side of the control housing portion 186 with the components mounted to the surface of the circuit board 190 facing the other, front side of the control housing portion 186. In addition, the components are mounted at or near the upper side edge of the circuit board 190 to be adjacent the upper surface 160 of the control portion 132. The circuit board 190 may be secured to the rear housing portion 182 via one or more fasteners 192.

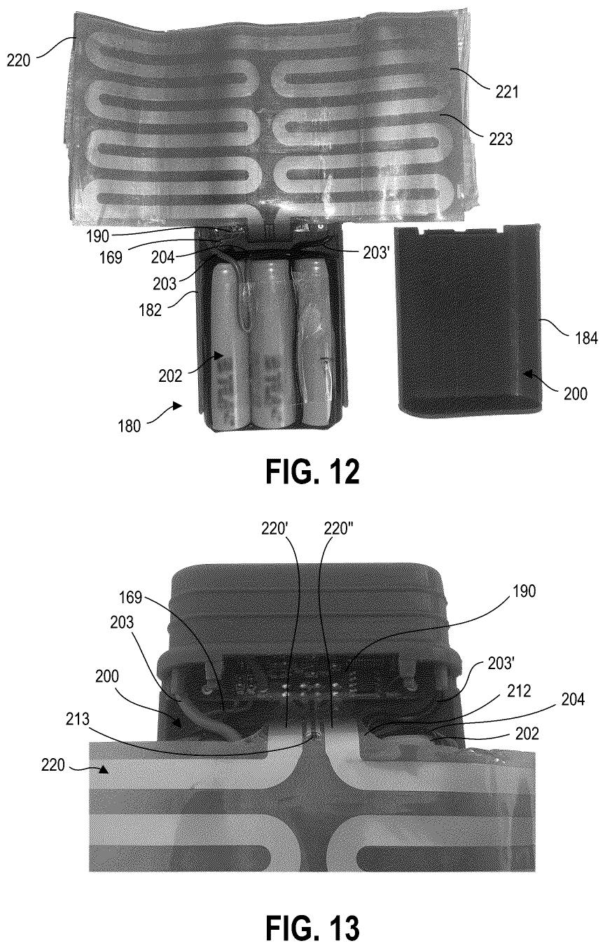

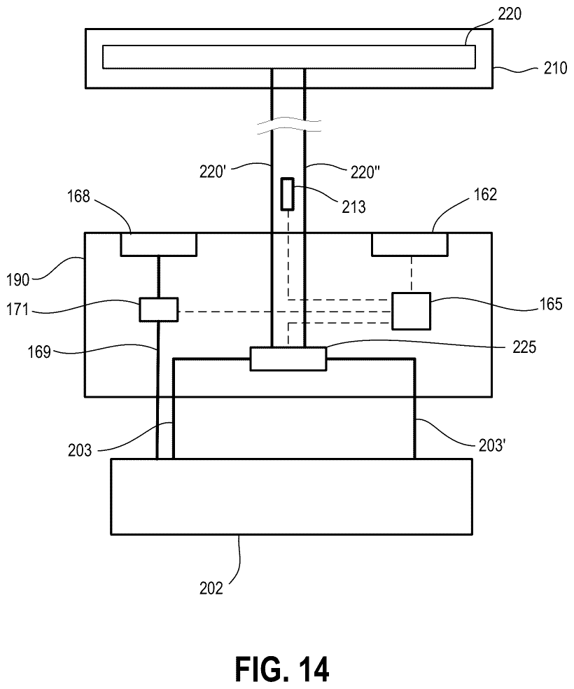

As mentioned, the housing 180 is sized and configured such that it forms the internal cavity or battery compartment 200 therein. The battery compartment 200 is sized to receive a rechargeable power source, which may be in the form of one or more (e.g., two or three) batteries 202. The batteries 202 may be lithium-ion batteries, and may be in the form of cylindrical batteries (e.g., rechargeable lithium-ion 18650 batteries). Although multiple cylindrical batteries 202 are shown, a single power source (e.g., a battery pack) may be provided. Upper and lower battery metallic strips or plates 204, 206 are provided and include battery terminals for forming a circuit between the batteries 202. The upper battery plate 204 is electrically connected to the recharging socket 168 via charging wires 169 (FIGS. 12-14) to allow recharging power to be supplied to the batteries 202. As shown in FIG. 14, the warming device 100 may include a charging controller 171 between the recharging socket 168 and the batteries 202 to control power provided by the recharging socket 168 to the batteries 202. The charging controller 171 may be communicatively coupled to the processor 165 to convey a charge status of the batteries 202 to the processor 165.

The inner core 104 of the warming device 100 further includes a thin, flexible heating layer or sleeve 210 for generating heat about the perimeter of the inner core 104. The heating sleeve 210 may be formed, for example, of a thin, flexible polyimide film such as Kapton having good dielectric properties, physical durability, and heat durability. As shown in FIG. 12, the heating sleeve 210 may be a generally planar sheet prior to assembly about the housing 180. An inner surface 221 of the heating sleeve 210 includes an adhesive layer 223 that may extend across substantially the entirety of the inner surface 221. With the rear housing portion 182 and the front housing portion 184 brought together with the batteries 202 therebetween, the heating sleeve 210 is then wrapped around exterior surface portions 230, 232, 234, 236 of the housing 180, and the adhesive layer 223 acts to secure the rear housing portion 182 to the front housing portion 184. In this way, the heating sleeve 210 completes assembly of the housing 180 with the batteries 202 received within the battery compartment 200.

The heating sleeve 210 includes resistive heating coil traces 220 that receive power from the batteries 202 and are operable to convert the electrical current into heat emitted from the coil traces 220. The coil traces 220 extend throughout the heating sleeve 210 in a serpentine pattern, as shown in FIGS. 5 and 8-12. As shown in FIG. 4, the heating sleeve 210 has a height that generally corresponds to a height of the lower, heating portion 130 such that the heating sleeve 210 extends to or closely adjacent to a bottom edge 131 of the lower, heating portion 130, and upwardly to or closely adjacent to an upper edge 133 of the lower, heating portion 130. For example, the heating sleeve 210 may extend to about 0.25 inches from the bottom edge 131, and to about 0.25 inches from the upper edge 133. In this manner, the heating sleeve 210 is operable so that the warming device 100 emits heat about substantially the entirety of the lower, heating portion 130, as discussed below.

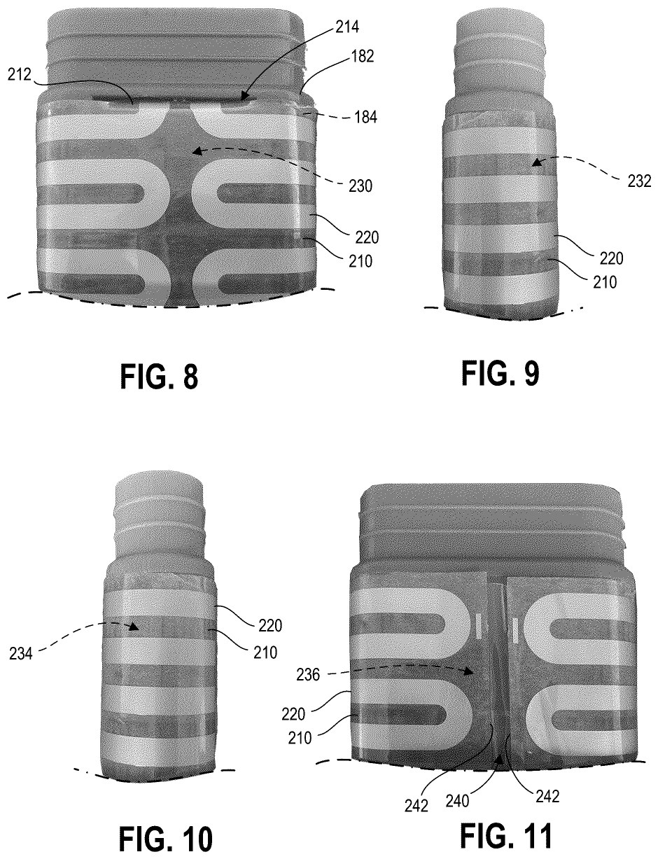

Referring to FIG. 5, the heating sleeve 210 includes an upper tab portion 212 that extends from an upper edge 211 of the sleeve 210 generally centrally along the front surface 230 of the front housing portion 184 when the sleeve 210 is wrapped therearound. The upper tab portion 212 protrudes through a gap or slot 214 formed in the housing 180. The gap 214 may be formed in the front surface portion 230, rear surface portion 236, or an end surface portion 232, 234 of the warming device 100. The gap 214 may be formed, for example, in the front surface portion 230 between adjacent portions of the rear housing portion 182 and the front housing portion 184, as shown in FIG. 8. For example, referring to FIG. 5, a first notch or cut-out 183 may be formed centrally in a lower free edge 188 of the cantilevered portion 195 of the arcuate shoulder surface 145, and a second notch or cut-out 185 may be formed centrally in an upper edge 189 of the front housing portion 184 that is generally aligned with the lower free edge 188 of the rear housing portion 182. In this manner, the first notch 183 and the second notch 185 cooperate to form the gap 214 through which the upper tab portion 212 protrudes.

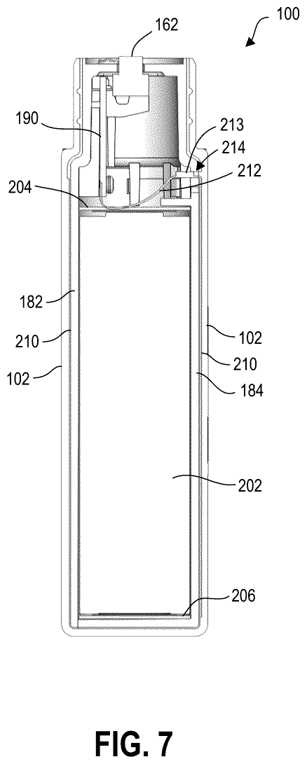

As shown in FIGS. 7 and 13, the tab portion 212 including portions of the electrical traces 220 extends into the battery compartment 200 and is secured (e.g., soldered) to the circuit board 190 such that the coil traces 220 are in electrical contact with the circuit board 190. As the batteries 202 are also in electrical contact with the circuit board 190 (see wires 203, 203′ in FIGS. 12-14), the resistive heating coil traces 220 are operable to convert power from the batteries 202 into heat, as discussed below.

As discussed, the heating sleeve 210 is of a flexible material so that it can form a continuous or nearly continuous wrap around the housing 180 of the inner core 104. For example, as shown in FIGS. 8-11, the heating sleeve 210 extends about substantially the entirety of a front flat surface portion 230 of the housing 180 (FIG. 8), along substantially the entirety of the opposite first and second arcuate end surface portions 232, 234 of the housing 180 (FIGS. 9 and 10), and substantially the entirety of a rear flat surface portion 236 of the housing 180. As shown in FIGS. 5 and 11, the heating sleeve 210 may have terminal end edges 240 that form a narrow spacing or gap 242 therebetween along the rear face 236 of the housing 180. The gap 242 may be in the range, for example, between approximately 0.125 inches to approximately 0.25 inches. In other approaches, the terminal end edges 240 meet such that the heating sleeve 210 does not form a gap at the rear surface 236 of the housing 180. In this way, the heating sleeve 210 provides heat about the entire perimeter about 360 degrees (100%), or nearly 360 degrees, including along the front surface portion 230, rear surface portion 236, and both end surface portions 232, 234 of the warming device 100. Because the outer jacket 102 wraps around the entire perimeter of the inner core 104 and receives and diffuses heat from the heating sleeve 210, the warming device 100 is able to provide heat about its entire perimeter.

When the warming device 100 is in an “on” or heating mode of operation, current from the batteries 202 is passed through a current regulator such as a transistor 225 (see FIG. 14) and to the coil traces 220. The transistor 225 is controlled by the processor 165 such that the transistor 225 regulates current flow to the coil traces 220 based on a user-selected operating mode. Due to the resistive property of the coil traces 220, the current flow causes the coil traces 220 to rise in temperature. As discussed, the main body 120 of the outer jacket 102 forms an intimate, tight fit about the entire perimeter of inner core 104. This tight fit provides efficient heat transfer from the inner core 104 to the main body 120 so that when the user grips the main body 120, the user will feel the warmth generated by the heating sleeve 210 about the entire perimeter of the warming device 100. More particularly, a user may grip the warming device 100 such that the front surface portion 230 is pressed against the user's palm, and the user's fingertips grip the rear surface portion 236 (or vice versa). As both end surface portions 232, 234 of the warming device 100 are also heated by the coil traces 220, intermediate portions of the user's fingers (e.g., middle and proximal phalanges) are also warmed by the warming device 100. In this way, the warming device 100 may provide full-hand coverage during use.

As shown in FIGS. 5, 7, 13, and 14, the warming device 100 may include a temperature sensor that may be in the form of a thermally sensitive resistor, such as thermistor 213, for sensing the temperature of the heating sleeve 210. As shown in FIG. 13, the thermistor 213 may be positioned on the tab portion 212 (e.g., between the positive and negative terminals 220′, 220″ of the coil traces 220) and is communicatively coupled to the processor 165. The processor 165 controls current flow to the coil traces 220 (via the transistor 225), and therefore controls the temperature of the warming device 100, based on the user-selected operating mode and the temperature sensed at the thermistor 213.

The batteries 202 may be recharged via the recharging socket 168 to allow for over 6 hours of heating while the warming device 100 is in “high heat” mode. Furthermore, the outer jacket 102 provides a waterproof cover to protect the components of the inner core 104 from water and dust so as to allow for rugged outdoor use of the warming device 100. For example, the outer jacket 102 covers and protects openings in the upper surface 160 of the control portion 132, such as at the switch device 162, the first light 164, the second series of lights 166, and the recharging socket 168.

While there have been illustrated and described particular embodiments of the present invention, those skilled in the art will recognize that a wide variety of modifications, alterations, and combinations can be made with respect to the above-described embodiments without departing from the scope of the invention, and that such modifications, alterations, and combinations are to be viewed as being within the ambit of the inventive concept.

What is claimed is:

1. A personal warming device comprising:
an inner core having an internal cavity and a front outer surface portion, a rear outer surface portion, and opposite first and second end outer surface portions interconnecting the front and rear outer surface portions with an outer perimeter of the inner core extending about the front, rear, and end outer surface portions;
a power source housed in the cavity;
an outer jacket of a resilient, heat transmissible material and being sized so that the outer jacket has a snug fit on the inner core and encases the inner core therein; and
a heating layer between the inner core and the outer jacket, the heating layer being electrically connected to the power source to receive power therefrom and being sized and configured to extend substantially entirely and continuously about the outer perimeter of the inner core such that the heating layer wraps along the front surface portion, along the opposite first and second end surface portions, and along the rear surface portion for generating and distributing heat substantially entirely about the outer perimeter of the inner core and through the outer jacket.

2. The personal warming device of claim 1 wherein the heating layer is a thin, flexible film that is wrapped about and secured on the outer surface portions of the inner core.

3. The personal warming device of claim 1 wherein the heating layer includes resistive heating coil traces that extend about the outer perimeter of the inner core.

4. The personal warming device of claim 3 wherein the resistive heating coil traces extend about the outer perimeter of the inner core in a serpentine pattern.

5. The personal warming device of claim 1 wherein the inner core includes a housing forming the internal cavity containing the power source and including the front, rear, and end outer surface portions, and the housing has a gap formed in one of the outer surface portions, and the heating layer includes a tab portion sized to extend through the gap for being electrically connected to the power source.

6. The personal warming device of claim 5 wherein the outer jacket extends over and covers the gap of the inner core.

7. The personal warming device of claim 5 wherein the tab portion extends from an upper edge of the heating layer centrally along the front outer surface portion.

8. The personal warming device of claim 1 wherein the inner core further includes an upper surface having a user interface including an actuator for controlling heating provided by the heating layer, and the outer jacket includes a cap having an upper wall that extends over the upper surface of the inner core with the upper wall having a projection aligned with the actuator for being pressed by a user for shifting the actuator.

9. A personal warming device comprising:
an inner core having a lower heating portion including an internal cavity, outer side and end surfaces, and an upper control portion including an upper surface forming a user interface region, the upper control portion having a smaller cross-section than the lower heating portion;
a power source housed in the internal cavity;
a heating layer wrapped about the outer side and end surfaces of the lower heating portion and operatively coupled to the power source;
an outer jacket including a main body portion that extends about the heating layer wrapped about the lower heating portion, and a neck that extends from the main body portion, the neck having a smaller cross-section than the main body portion to extend about the upper control portion; and
a cap of the outer jacket configured to be removably retained over and about the neck to selectively cover the user interface region and form a seal with the outer jacket.

10. The personal warming device of claim 9 wherein the cap is sized to form a friction fit with the neck to provide a substantially fluid-tight seal in compliance with an Ingress Protection (IP) rating of IPX7 with the neck with the cap retained over and about the neck.

11. The personal warming device of claim 9 wherein the outer jacket is sized to have an intimate, tight fit about the inner core to avoid air gaps between the outer jacket main body portion and the heating layer for efficient heat transfer to the outer jacket and to a user's hand engaged thereon.

12. The personal warming device of claim 9 wherein the cap has wall portions including outer side and end surfaces, with the cap being sized and configured so that the outer side and end surfaces thereof are substantially flush with the outer side and end surfaces of the main body portion with the cap removably retained over and about the neck.

13. The personal warming device of claim 9 wherein the user interface region includes a user-actuatable switch device, and the outer jacket including the cap thereof are of a resilient material with the cap being configured to extend over and cover the user-actuatable switch device with the cap removably retained over and about the neck so that a user can push on a portion of the cap aligned with the user-actuatable switch device for actuation thereof.

14. The personal warming device of claim 9 wherein the user interface region includes a recharging socket, the cap configured to extend over and cover the recharging socket with the cap removably retained over and about the neck.

15. The personal warming device of claim 9 wherein the user interface region includes at least one LED, and the outer jacket including the cap thereof is of a light transmissive material, the cap configured to extend over and cover the at least one LED with the cap removably retained over and about the neck so that light from the at least one LED is visible through the cap.

16. The personal warming device of claim 15 wherein the cap has a reduced thickness region that extends over the at least one LED to enhance visibility of the at least one LED with the cap removably retained over and about the neck.

17. The personal warming device of claim 16 wherein the upper control portion includes a plurality of spaced annular ribs extending thereabout with the neck of the outer jacket being tightly engaged thereagainst for forming a seal therebetween.

18. The personal warming device of claim 9 wherein the cap is integrally formed with the main body portion of the outer jacket.

19. The personal warming device of claim 18 wherein the cap is connected to the main body portion of the outer jacket via a living hinge.

20. The personal warming device of claim 9 wherein the outer jacket including the cap is of a silicone material.
